(19) United States
(12) Patent Application Publication
(10) Pub. No.: US 2026/0245910 A1
(43) Pub. Date: Aug. 20, 2026

(54) POSITIVE ELECTRODE LAYER FOR ALL-SOLID-STATE RECHARGEABLE BATTERY, MANUFACTURING METHOD OF THE SAME, AND ALL-SOLID-STATE RECHARGEABLE BATTERY INCLUDING THE SAME

(71) Applicant: SAMSUNG SDI CO., LTD., Yongin-si, Gyeonggi-do (KR)

(72) Inventors: Mijung JUNG, Yongin-si, Gyeonggi-do (KR); Seonhyeok AN, Yongin-si, Gyeonggi-do (KR); Seunghyun OH, Yongin-si, Gyeonggi-do (KR)

(73) Assignee: SAMSUNG SDI CO., LTD., Yongin-si, Gyeonggi-do (KR)

(21) Appl. No.: 18/879,016

(22) PCT Filed: Nov. 3, 2023
(86) PCT No.: PCT/KR2023/017506

§ 371 Date: Dec. 26, 2024

(30) Foreign Application Priority Data
Nov. 10, 2022 (KR) 10-2022-0149823

(51) Int. Cl. H01M 4/62; H01M 4/02; H01M 4/04; H01M 4/131; H01M 4/1391; H01M 4/36; H01M 4/525

(52) U.S. Cl. CPC H01M 4/628; H01M 4/0404; H01M 4/0471; H01M 4/131; H01M 4/1391; H01M 4/366; H01M 4/525; H01M 4/623; H01M 4/625; H01M 2004/028

(57) ABSTRACT

Disclosed are a positive electrode layer for an all-solid-state rechargeable battery, a method of manufacturing the same, and an all-solid-state rechargeable battery including the same. In an embodiment, the positive electrode layer for an all-solid-state rechargeable battery includes a positive electrode current collector; and a positive electrode active material layer located on the positive electrode current collector and including a solid electrolyte composite and a positive electrode active material; wherein the solid electrolyte composite includes a core including diamagnetic particles having an aspect ratio represented by Equation 1 of greater than 1; and a shell surrounding the core and including a solid electrolyte.

### TECHNICAL FIELD

Positive electrode layers for all-solid-state rechargeable batteries, methods of manufacturing the same, and all-solid-state rechargeable batteries including the same are disclosed.

### BACKGROUND ART

Recently, development of batteries with high energy density and safety is being actively pursued due to industrial demands. For example, lithium-ion batteries are being commercialized in the automotive field as well as in the information-related devices and communication devices.

Lithium-ion batteries currently on the market use electrolytes, and because the electrolytes include flammable organic dispersion media, there is a risk of overheating and fire if a short circuit occurs inside the battery. In this regard, an all-solid-state rechargeable battery using a solid electrolyte instead of an electrolyte is being proposed.

All-solid-state rechargeable batteries do not use flammable organic dispersion media, and thus the possibility of fire or explosion occurring even if a short circuit occurs can be greatly reduced. Accordingly, these all-solid-state batteries can significantly improve safety compared to lithium-ion batteries that use electrolytes.

However, all-solid-state rechargeable batteries have lower lithium ionic conductivity than lithium ion batteries. In this regard, methods are being examined to shorten the lithium ion movement path within the all-solid-state battery electrode layer, such as forming holes or pores and filling the interiors thereof with a solid electrolyte, or adding additives that increase lithium ionic conductivity.

However, when holes or pores are formed, there is a limit to filling the interiors thereof with a solid electrolyte without any gaps, and even if additives are added, side reactions may occur between the solid electrolyte and the additives or the properties of the slurry for forming the electrode layer may be affected, and thus there are limits to the selection of additives.

### DISCLOSURE

Provided is a positive electrode capable of improving the ionic conductivity of an all-solid-state rechargeable battery while enhancing high-rate capability.

In an embodiment, a positive electrode layer for an all-solid-state rechargeable battery is provided, wherein a solid electrolyte composite is oriented in a direction perpendicular or nearly perpendicular to a positive electrode current collector in the positive electrode active material layer.

In another embodiment, an all-solid-state rechargeable battery including the positive electrode layer is provided.

The positive electrode layer of an embodiment can shorten a lithium ion movement path in the positive electrode layer (particularly, the positive electrode active material layer) and reduce an interfacial contact resistance between the positive electrode layer and the solid electrolyte layer by orienting the solid electrolyte composite in a direction perpendicular or nearly perpendicular to the positive electrode current collector.

Accordingly, an all-solid-state rechargeable battery including a positive electrode layer of an embodiment can have improved ionic conductivity and enhanced high-rate capability.

### DESCRIPTION OF THE DRAWINGS

FIG. 1 is a schematic view of a solid electrolyte composite 1 included in a positive electrode layer 200 according to an embodiment.

FIG. 2 is a schematic view of a positive electrode layer 200 according to an embodiment.

FIGS. 3 and 4 are cross-sectional views schematically showing an all-solid-state rechargeable battery 100 according to an embodiment.

### BEST MODE

Hereinafter, specific embodiments will be described in detail so that those of ordinary skill in the art can easily implement them. However, this disclosure may be embodied in many different forms and is not construed as limited to the example embodiments set forth herein.

The terminology used herein is used to describe embodiments only, and is not intended to limit the present disclosure. The singular expression includes the plural expression unless the context clearly dictates otherwise.

“Combination thereof” means a mixture, a laminate, a composite, a copolymer, an alloy, a blend, a reaction product, and the like of the constituents.

It should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, etc., are exaggerated for clarity and like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

“Layer” herein includes not only a shape formed on the whole surface when viewed from a plan view, but also a shape formed on a partial surface.

“Particle diameter” or “average particle diameter” may be measured by a method well known to those skilled in the art, for example, may be measured by a particle size analyzer, or may be measured by a transmission electron microscope photograph or a scanning electron microscope photograph. Alternatively, it is possible to obtain an average particle diameter value by measuring using a dynamic light scattering method, performing data analysis, counting the number of particles for each particle size range, and calculating from this. Unless otherwise defined, the average particle diameter may mean the diameter (D50) of particles having a cumulative volume of 50 volume % in the particle size distribution.

“Thickness” may be measured, for example, from photographs taken with an optical microscope such as a scanning electron microscope.

(Positive Electrode Layer for all-Solid-State Rechargeable Battery)

In an embodiment, a positive electrode layer for an all-solid-state rechargeable battery includes a positive electrode current collector; and a positive electrode active material layer located on the positive electrode current collector and including a solid electrolyte composite and a positive electrode active material; wherein the solid electrolyte composite includes a core including diamagnetic particles having an aspect ratio represented by Equation 1 of greater than 1; and a shell surrounding the core and including a solid electrolyte.

$$Aspect ratio = length of major axis / length of minor axis \qquad [ Equation 1 ]$$

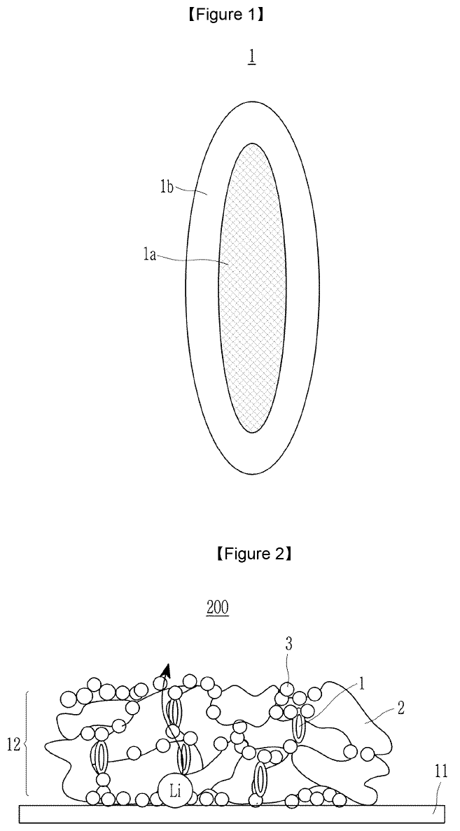

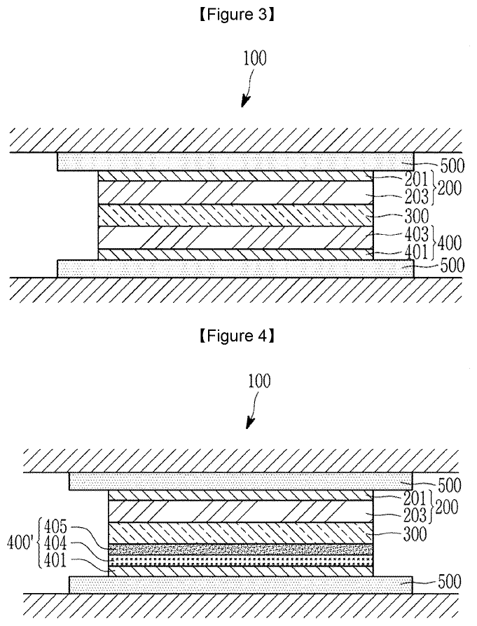

FIG. 1 is a schematic view of a solid electrolyte composite 1 included in a positive electrode layer 200 according to an embodiment, FIG. 2 is a schematic view of a positive electrode layer 200 according to an embodiment, and FIG. 3 is a schematic view of an all-solid-state rechargeable battery 100 including a positive electrode layer 200 according to an embodiment.

In order to shorten the lithium ion movement path within the positive electrode layer (particularly, the positive electrode active material layer), a method of orienting the non-spherical solid electrolyte particles themselves in the positive electrode active material layer 203 perpendicularly to the positive electrode current collector 201 can be considered.

However, in a general method of forming a positive electrode active material layer 203 by coating a positive electrode active material slurry including non-spherical solid electrolyte particles onto a positive electrode current collector 201, the non-spherical solid electrolyte particles are only randomly distributed in the positive electrode active material layer 203.

Meanwhile, in order to orient specific non-spherical particles in the positive electrode active material layer 203 vertically with respect to the positive electrode current collector 201, a method of coating a positive electrode active material slurry including specific non-spherical particles onto the positive electrode current collector 201 and then applying a magnetic field may be considered.

Here, the orientation of a specific non-spherical particle is controlled by a magnetic field only when the specific non-spherical particle has the property of diamagnetism. However, among the solid electrolytes known to date, there is no material that exhibits diamagnetic properties.

In an embodiment, to solve the above problem, a solid electrolyte composite 1 having a core 1a including non-spherical diamagnetic particles; and a shell 1b including a solid electrolyte formed on the core; is used to control the orientation properties of the solid electrolyte composite 1 in the positive electrode active material layer 203.

Specifically, by orienting the solid electrolyte composite 1 in a direction perpendicular or nearly perpendicular (for example, 50° to 130°) to the positive electrode current collector 201, the lithium ion movement path within the positive electrode layer (particularly, the positive electrode active material layer) can be shortened, and the interfacial contact resistance between the positive electrode layer 200 and the solid electrolyte layer 30 can be reduced. Accordingly, an all-solid-state rechargeable battery 100 including a positive electrode layer 200 of an embodiment can have improved ionic conductivity and enhanced high-rate capability.

Hereinafter, the components constituting the positive electrode layer 200 of an embodiment are described in more detail.

### Solid Electrolyte Composite

The solid electrolyte composite 1 is a composite having a core 1a-shell 1b structure, and includes a core 1a including non-spherical diamagnetic particles, and a shell 1b surrounding the core and including a solid electrolyte.

In the solid electrolyte composite 1, the non-spherical diamagnetic particles included in the core 1a may have an aspect ratio expressed by Equation 1 of greater than 1, greater than or equal to 1.5, greater than or equal to 2, or greater than or equal to 3.

These non-spherical diamagnetic particles and the solid electrolyte composite 1 including them may be oriented in a direction perpendicular or nearly perpendicular (for example, 50° to 130°) to the positive electrode current collector 201 by an externally applied magnetic field. Furthermore, as the aspect ratio represented by Equation 1 increases, the performance of an all-solid-state rechargeable battery including a positive electrode layer according to an embodiment can be improved.

However, the larger the aspect ratio represented by Equation 1, the more difficult it is to manufacture the solid electrolyte composite 1, or the stronger the magnetic field is required to orient the solid electrolyte composite 1 in a direction close to perpendicular (50° to 130°) to the positive electrode current collector 201. Considering the difficulties in the process or the manufacturing cost, the upper limit of the aspect ratio represented by Equation 1 may be less than or equal to 5,000, less than or equal to 300, or less than or equal to 10.

Additionally, in the solid electrolyte composite 1, the thickness of the shell 1b may be uniform or non-uniform. Specifically, the solid electrolyte composite 1 can satisfy Equation 2, Equation 3, or both. In this range, the solid electrolyte composite 1 can be effectively oriented in a direction perpendicular or nearly perpendicular to the positive electrode current collector by a magnetic field applied from the outside.

$$0.1 \leq A / C \leq 100 \qquad [ Equation 2 ]$$

$$0.01 \leq B / C \leq 10 \qquad [ Equation 3 ]$$

In the above mathematical expressions 2 and 3, A is a major axis length of the core 1a, B is a minor axis length of the core 1a, and C is a thickness of the shell 1b.

Specifically, the solid electrolyte composite 1 may satisfy Equation 2-1, Equation 3-1, or both:

$$1 \leq A / C \leq 20 \qquad [ Equation 2 - 1 ]$$

$$0.05 \leq B / C \leq 5 \qquad [ Equation 3 - 1 ]$$

The definitions of A, B, and C in Equations 2-1 and 3-1 are as described above.

More specifically, the major axis length of the core 1a may be μm to 50 μm, or 5 to 20 μm, and the minor axis length may be 10 nm to 5 μm, or 100 nm to 3 μm. Additionally, the thickness of the shell 1b may be 100 nm to 10 μm, or 1 μm to 5 μm. Additionally, the solid electrolyte composite may include a core 1a and a shell 1b in a weight ratio of 1:1 to 1:500, or 1:10 to 1:100. In this range, the orientation effect by the core 1a and the lithium ion conduction effect by the shell 1b can be harmonized.

The major axis of the solid electrolyte composite 1 in the positive electrode active material layer may be oriented in a direction of 50° to 130°, specifically 70° to 110°, more specifically 85° to 95°, for example, perpendicular (90°) to the positive electrode current collector. When the angle formed by the major axis of the solid electrolyte composite 1 with respect to the positive electrode current collector is within the above range, the lithium ion movement path within the positive electrode layer (particularly, the positive electrode active material layer) can be shortened, and the interfacial contact resistance between the positive electrode layer and the solid electrolyte layer can be reduced.

Meanwhile, in the solid electrolyte composite 1, the core 1a is not particularly limited as long as the aspect ratio represented by Equation 1 exceeds 1. For example, the core 1a may have a needle-shape, plate-shape, or oval shape and may include a carbon-based material selected from artificial graphite, natural graphite, graphene, a carbon nanotube (CNT), an L-carbon nanotube (long length CNT), a carbon fiber, carbon black, or a combination thereof as diamagnetic particles.

Additionally, in the solid electrolyte composite 1, the shell 1b may include a generally known solid electrolyte. Specifically, the shell may include a sulfide-based solid electrolyte, an oxide-based solid electrolyte, a polymer-based solid electrolyte, or a solid electrolyte selected from these. Examples of the sulfide-based solid electrolytes may include one or more selected from Li₂S—P₂S₅, Li₂S—P₂S₅—LiX (wherein, X is a halogen element), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (wherein, m and n are positive numbers, and Z is one of Ge, Zn, or Ga), Li₂S—GeS₂, Li₂S—SiS₂—Li₃PO₄, Li₂S—SiS₂—LiₚMO_{q} (wherein, p and q are positive numbers, and M is one of P, Si, Ge, B, Al, Ga, and In), Li₇₋ₓPS₆₋ₓClₓ, 0≤x≤2, Li₇₋ₓPS₆₋ₓBrₓ (wherein, 0≤x≤2), and Li₇₋ₓPS₆₋ₓIₓ (wherein, 0≤x≤2).

For example, the shell 1b of the solid electrolyte composite 1 may be Li₆PS₅Cl, which is a type of argyrodite-type sulfide-based solid electrolyte.

The content of the solid electrolyte composite 1 may be 0.05 to 30 wt %, or 7 to 17 wt %, based on the total weight of the positive electrode active material layer 203. In this range, the lithium ion conduction effect according to the solid electrolyte composite 1 and the capacity securing effect by the positive electrode active material 2 can be harmonized.

### Positive Electrode Active Material

The positive electrode active material 2 is a positive electrode active material that can reversibly absorb and desorb lithium ions. Examples of the positive electrode active material include lithium transition metal oxides such as lithium cobalt oxide, lithium nickel oxide, lithium nickel cobalt oxide, lithium nickel cobalt aluminum oxide, lithium nickel cobalt manganese oxide, lithium manganese oxide, and lithium iron phosphate; nickel sulfide; copper sulfide; lithium sulfide; iron oxide, vanadium oxide, and the like; but are not necessarily limited thereto, and any material used as a positive electrode active material in the relevant technical field may be used. The positive electrode active materials are each singular or a mixture of two or more types.

The lithium transition metal oxide may include a composite oxide of lithium and nickel, manganese, cobalt, or a combination thereof. For example, it may include any one compound represented by LiₐA_{1-b}B_{b}D₂ (wherein, in the chemical formula, 0.90≤a≤1, and 0≤b≤0.5); LiₐE_{1-b}B_{b}O_{2-c}D_{c} (wherein, in the chemical formula, 0.90≤a≤1, 0≤b≤50.5, 0≤c≤0.05); LiE_{2-b}B_{b}O_{4-c}D_{c} (wherein, in the chemical formula, 0≤b≤0.5, 0≤c≤0.05); LiₐNi_{1-b-c}Co_{b}B_{c}D_{α} (wherein, in the chemical formula, 0.90≤a≤1, 0≤b≤0.5, 0≤c≤0.05, 0<α<2); LiₐNi_{1-b-c}Co_{b}B_{c}O₂₋ₐF_{α} (wherein, in the chemical formula, 0.90≤a≤1, 0≤b≤0.5, 0:5≤c≤0.05, 0<α<2); LiₐNi_{1-b-c}CO_{b}B_{c}O_{2-α}F₂ (wherein, in the chemical formula, 0.90≤a≤1, 0≤b≤0.5, 0≤c≤0.05, 0<α<2); LiₐNi_{1-b-c}Mn_{b}B_{c}D_{α} (wherein, in the chemical formula, 0.90≤a≤1, 0≤b≤0.5 0≤c≤0.05, 0<α≤2); LiₐNi_{1-b-c}Mn_{b}B_{c}O_{2-α}F_{α} (wherein, in the chemical formula, 0.90≤a≤1, 0≤b≤0.5, 0:5≤c≤0.05, 0<α<2); LiₐNi_{1-b-c}Mn_{b}B_{c}O_{2-α}F₂ (wherein, in the chemical formula, 0.90≤a≤1, 0≤b≤0.5, 0:5≤c≤0.05, 0<α<2); LiₐNi_{b}E_{c}G_{d}O₂ (wherein, in the chemical formula, 0.90≤a≤1, 0≤b≤0.9, 0≤c≤0.5, 0.001≤d≤0.1); LiₐNi_{b}Co_{c}Mn_{d}GeO₂ (wherein, in the chemical formula, 0.90≤a≤1, 0≤b≤0.9, 0≤c≤0.5, 0≤d≤0.5, 0.001≤e≤0.1); LiₐNi_{b}G_{d}O₂ (wherein, in the chemical formula, 0.9≤a≤1, 0.001≤b≤0.1); LiₐCoG_{b}O₂ (wherein, in the chemical formula, 0.90≤a≤1, 0.001≤b≤0.1); LiₐMnG_{b}O₂ (wherein, in the chemical formula, 0.90≤a≤1, 0.001≤b≤0.1); LiₐMn₂G_{b}O₄ (wherein, in the chemical formula, 0.90≤a≤1, 0.001≤b≤0.1); QO₂; QS₂; LiQS₂; V₂O₅; LiV₂O₅; LiIO₂; LiNiVO₄; Li_{(3-f)}J₂(PO₄)₃ (0≤f≤2); Li_{(3-f)}Fe₂(PO₄)₃ (0≤f≤2); or LiFePO₄. In these compounds, A is Ni, Co, Mn, or a combination thereof; B is Al, Ni, Co, Mn, Cr, Fe, Mg, Sr, V, a rare earth element, or a combination thereof; D is O, F, S, P, or a combination thereof; E is Co, Mn, or a combination thereof; F is F, S, P, or a combination thereof; G is Al, Cr, Mn, Fe, Mg, La, Ce, Sr, V, or a combination thereof; Q is Ti, Mo, Mn, or a combination thereof; I is Cr, V, Fe, Sc, Y, or a combination thereof; and J is V, Cr, Mn, Co, Ni, Cu, or a combination thereof. It is also possible to use a compound having a coating layer added to the surface of such a compound, and it is also possible to use a mixture of the aforementioned compound and a compound having a coating layer added. The coating layer added to the surface of such a compound includes a coating element compound, for example, an oxide of the coating element, a hydroxide of the coating element, an oxyhydroxide of the coating element, an oxycarbonate of the coating element, or a hydroxycarbonate of the coating element. The compounds forming these coating layers are amorphous or crystalline. The coating element included in the coating layer include Mg, Al, Co, K, Na, Ca, Si, Ti, V, Sn, Ge, Ga, B, As, Zr, or a mixture thereof. The method of forming the coating layer is selected within a range that does not adversely affect the properties of the positive electrode active material. The coating method include, for example spray coating, dipping, etc. Because the specific coating method is well understood by those working in the field, a detailed description thereof will be omitted.

The positive electrode active material includes, for example, a lithium salt of a transition metal oxide having a layered rock salt type structure among the lithium transition metal oxides described above. The “layered rock salt type structure” is a structure in which oxygen atomic layers and metal atomic layers are arranged alternately and regularly in the <111> direction, for example, in the cubic rock salt type structure, and thereby each atomic layer forms a two-dimensional plane. The “cubic rock salt structure” refers to the sodium chloride type structure, which is a type of crystal structure, and specifically, it refers to a structure in which the face-centered cubic lattice (fcc) formed by each cation and anion is misaligned by half the ridge of the unit lattice. Lithium transition metal oxides having such a layered rock salt type structure are, for example, a ternary lithium transition metal oxide such as LiNiₓCo_{y}Al_{z}O₂ (NCA) or LiNiₓCo_{y}Mn_{z}O₂ (NCM) (0<x<1, 0<y<1, 0<z<1, x+y+z=1), and the like. When the positive electrode active material includes a ternary lithium transition metal oxide having a layered salt structure, the energy density and thermal stability of the all-solid-state rechargeable battery are further improved.

The positive electrode active material 2 may be covered by a coating layer as described above. The coating layer may be any material known as a coating layer for the positive electrode active material of an all-solid-state rechargeable battery. The coating layer is, for example, Li₂O—ZrO₂ (LZO).

When the positive electrode active material 2 includes nickel (Ni) as a ternary lithium transition metal oxide such as NCA or NCM, the capacity density of the all-solid-state rechargeable battery 100 can be increased, thereby reducing metal elution from the positive electrode active material in a charged state. As a result, the cycle characteristics of the all-solid-state rechargeable battery 100 in a charged state are improved.

The shape of the positive electrode active material 2 is, for example, a particle shape such as a sphere or an elliptical sphere. The particle size of the positive electrode active material is not particularly limited, and is within a range applicable to positive electrode active materials of generally known all-solid-state rechargeable batteries. The content of the positive electrode active material is not particularly limited, and is within the range applicable to the positive electrode of a generally known all-solid-state rechargeable battery.

A content of the positive electrode active material 2 may be 45 to 99.25 wt %, or 70 to 90 wt %, based on the total weight of the positive electrode active material layer 203. In this range, the lithium ion conduction effect according to the solid electrolyte composite 1 and the capacity securing effect by the positive electrode active material 2 can be harmonized.

### Additional Components of Positive Electrode Active Material Layer

The positive electrode active material layer 203 essentially includes the solid electrolyte composite 1 and the positive electrode active material 2, and may further include an amorphous sulfide-based solid electrolyte, a conductive material, a binder, or a combination thereof.

When the aforementioned amorphous sulfide-based solid electrolyte is further included, the ionic conductivity of the positive electrode layer can be further improved.

Examples of the amorphous sulfide-based solid electrolytes may include Li₂S—P₂S₅, Li₂S—P₂S₅—LiX (wherein, X is a halogen element), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (wherein, m and n are positive numbers, and Z is one of Ge, Zn, or Ga), Li₂S—GeS₂, Li₂S—SiS₂—Li₃PO₄, Li₂S—SiS₂—LiₚMO_{q} (wherein, p and q are positive numbers, and M is at least one of P, Si, Ge, B, Al, Ga, or In), Li₇₋ₓPS₆₋ₓClₓ, 0≤x≤2, Li₇₋ₓPS₆₋ₓBrₓ (wherein, 0≤x≤2), and Li₇₋ₓPS₆₋ₓIₓ (wherein, 0≤x≤2).

The components constituting the amorphous sulfide-based solid electrolyte may be the same as the shell 1b of the solid electrolyte composite 1. For example, when the shell 1b of the solid electrolyte composite 1 is composed of Li₆PS₅Cl, the amorphous sulfide-based solid electrolyte may also be composed of Li₆PS₅Cl.

A content of the amorphous sulfide-based solid electrolyte may be 0.5 wt % to 30 wt %, for example, 1 wt % to 5 wt %, based on the total weight of the positive electrode active material layer 203.

The conductive material (not shown) is used to provide conductivity to the electrode, and in the battery to be formed, any material that does not cause a chemical change and is electronically conductive can be used, and may be at least one selected from graphite, carbon black, acetylene black, a carbon nanofiber, and a carbon nanotube.

In addition, the binder (not shown) serves to attach the solid electrolyte composite 1 particles and the positive electrode active material 2 particles well to each other and also to attach them well to the positive electrode current collector 201, and may be at least one selected from polyvinylidene fluoride, a styrene butadiene rubber, polytetrafluoroethylene, polyvinylidene fluoride, a vinylidene fluoride/hexafluoropropylene copolymer, polyacrylonitrile, and polymethyl methacrylate.

Each content of the binder (not shown) and the conductive material (not shown) may be 0.1 wt % to 10 wt % and 0.1 wt % to 5 wt %, respectively, based on the total weight of the positive electrode active material layer 203.

The positive electrode active material layer 203 may further include additives (not shown) such as a filler, a coating agent, a dispersant, and an ion conductive auxiliary agent in addition to the above-described solid electrolyte composite 1, positive electrode active material 2, binder (not shown), and conductive material (not shown). As the filler, coating agent, dispersant, ion conductive auxiliary agent, etc. that can be included in the positive electrode layer, known materials generally used in the positive electrode of an all-solid-state rechargeable battery can be used.

### Positive Electrode Current Collector

The positive electrode current collector 201 may be selected from an aluminum foil, a nickel foil, a stainless steel foil, a titanium foil, a nickel foam, a copper foam, a polymer substrate coated with a conductive metal, and a combination thereof. The aluminum foil may be used as the positive electrode current collector, but is not limited thereto.

(Method for Manufacturing Positive Electrode Layer for all-Solid-State Rechargeable Battery)

In another embodiment, a method for manufacturing a positive electrode layer for an all-solid-state rechargeable battery includes preparing a solid electrolyte composite including a core including diamagnetic particles having an aspect ratio represented by Equation 1 of greater than 1; and a shell surrounding the core and including a solid electrolyte; preparing a positive electrode slurry including the solid electrolyte composite and a positive electrode active material; coating the positive electrode slurry onto a positive electrode current collector; and applying a magnetic field to the positive electrode slurry coated onto the positive electrode current collector.

$$Aspect ratio = length of major axis / length of minor axis \qquad [ Equation 1 ]$$

This corresponds to a method for manufacturing a positive electrode layer of the aforementioned embodiment. Hereinafter, any description overlapped with the above will be omitted, and the steps for manufacturing the positive electrode layer of an embodiment will be described in more detail.

### Preparation of Solid Electrolyte Composite

The preparing of the solid electrolyte composite may include preparing a mixed solution by mixing a first solvent, diamagnetic particles having an aspect ratio represented by Equation 1 of greater than 1, and the solid electrolyte; drying the mixed solution; and heat-treating the dried material.

The first solvent is not particularly limited as long as it is a solvent capable of dispersing the diamagnetic particles having an aspect ratio represented by Equation 1 of greater than 1 and the solid electrolyte, but acetonitrile can be used.

In addition, the drying and heat-treating conditions are not particularly limited, but drying may be performed at 100 to 150° C. and heat-treating can be performed at 500 to 600° C., respectively.

The structure of the solid electrolyte composite prepared accordingly is as described above.

### Preparation of Positive Electrode Slurry

The preparing of the positive electrode slurry may include preparing a mixed slurry including a second solvent, the solid electrolyte composite, and a positive electrode active material.

The second solvent is not particularly limited as long as it is a solvent capable of dispersing the solid electrolyte composite and the positive electrode active material, but octyl acetate can be used.

When preparing the mixed slurry, the aforementioned binder, conductive material, or a combination thereof may be further added. Additionally, a dispersant generally known in the art (e.g., H-NBR, etc.) may be added.

### Coating of Positive Electrode Slurry

The coating of the positive electrode slurry onto the positive electrode current collector may utilize a coating method generally known in the art. For example, methods such as bar coating, spin coating, die coating, transfer coating, and spray coating can be used.

### Application of Magnetic Field

In applying of the magnetic field to the positive electrode slurry coated on the positive electrode current collector, the solid electrolyte composite randomly distributed on the positive electrode current collector can be oriented in a direction perpendicular or nearly perpendicular to the positive electrode current collector. At this time, a strength of the magnetic field may be 0.1 to 3 T or 0.5 to 2 T; and an application time may be 0.1 second to 10 minutes. There is no particular limitation on the temperature at which the magnetic field is applied, but the higher the temperature, the weaker the strength of the magnetic field, which may weaken the effect.

Steps after Magnetic Field Application

After applying a magnetic field to the positive electrode slurry coated on the positive electrode current collector, drying, compressing, etc. may be further performed.

Specifically, the method may further include applying a magnetic field to the positive electrode slurry coated on the positive electrode current collector; thereafter, drying the positive electrode slurry to which the magnetic field has been applied, thereby forming a positive electrode active material layer on the positive electrode current collector; and compressing the positive electrode current collector and the positive electrode active material layer formed on the positive electrode current collector. Here, conditions such as drying and compressing can be as generally known in the art.

(all-Solid-State Rechargeable Battery)

In another embodiment, an all-solid-state rechargeable battery includes: the positive electrode layer according to the aforementioned embodiment; a negative electrode layer; and a solid electrolyte layer between the positive electrode layer and the negative electrode layer. Because it includes a positive electrode layer according to the aforementioned embodiment, it can exhibit excellent ionic conductivity while also exhibiting high high-rate capability.

Hereinafter, any description overlapped with the above will be omitted, and the elements constituting the all-solid-state rechargeable battery of an embodiment will be described in more detail with reference to FIG. 3.

The all-solid-state rechargeable battery may also be expressed as an all-solid-state battery or an all-solid-state rechargeable lithium battery.

FIG. 3 is a cross-sectional view of an all-solid-state battery according to an embodiment. Referring to FIG. 3, the all-solid-state battery 100 may have a structure in which an electrode assembly in which a negative electrode layer 400 including a negative electrode current collector 401 and a negative electrode active material layer 403, a solid electrolyte layer 300, and a positive electrode layer 200 including a positive electrode active material layer 203 and a positive electrode current collector 201 are stacked is housed in a case such as a pouch. The all-solid-state battery 100 may further include an elastic layer 500 on the outer side of at least one of the positive electrode layer 200 and the negative electrode layer 400. FIG. 4 illustrates one electrode assembly including a negative electrode layer 400, a solid electrolyte layer 300, and a positive electrode layer 200, but an all-solid-state battery may also be manufactured by stacking two or more electrode assemblies.

### Negative Electrode Layer

The negative electrode layer for an all-solid-state battery may include, for example, a current collector and a negative electrode active material layer on the current collector. The negative electrode active material layer includes a negative electrode active material and may further include a binder, a conductive material, and/or a solid electrolyte.

The negative electrode active material may include a material that reversibly intercalates/deintercalates lithium ions, a lithium metal, a lithium metal alloy, a material capable of doping/dedoping lithium, or transition metal oxide.

The material that reversibly intercalates/deintercalates lithium ions may include, for example crystalline carbon, amorphous carbon, or a combination thereof as a carbon-based negative electrode active material. The crystalline carbon may be irregular, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and the like.

The lithium metal alloy may include an alloy of lithium and one or more metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOₓ (0<x<2), a Si-Q alloy (wherein Q is an alkali metal, an alkaline-earth metal, a Group 13 element, a Group 14 element, a Group 15 element, a Group 16 element, a transition metal, a rare earth element, and a combination thereof, but not Si) and the Sn-based negative electrode active material may include Sn, SnO₂, a Sn—R alloy (wherein R is an alkali metal, an alkaline-earth metal, a Group 13 element, a Group 14 element, a Group 15 element, a Group 16 element, a transition metal, a rare earth element, and a combination thereof, but not Sn). At least one of these materials may be mixed with SiO₂. The elements Q and R may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, and a combination thereof.

The silicon-carbon composite may be, for example, a silicon-carbon composite including a core including crystalline carbon and silicon particles and an amorphous carbon coating layer on the surface of the core. The crystalline carbon may be artificial graphite, natural graphite, or a combination thereof. The above amorphous carbon precursor may be coal-based pitch, mesophase pitch, petroleum-based pitch, coal-based oil, petroleum-based heavy oil, or a polymer resin such as a phenol resin, a furan resin, or a polyimide resin. In this case, the content of silicon may be 10 wt % to 50 wt % based on the total weight of the silicon-carbon composite. Additionally, a content of the crystalline carbon may be 10 wt % to 70 wt % based on a total weight of the silicon-carbon composite, and a content of the amorphous carbon may be 20 wt % to 40 wt % based on a total weight of the silicon-carbon composite. Additionally, the thickness of the amorphous carbon coating layer may be 5 nm to 100 nm.

The average particle size (D50) of the silicon particles may be 10 nm to 20 μm, for example, 10 nm to 500 nm. The silicon particles may exist in an oxidized form, and in this case, an atomic content ratio of Si:O in the silicon particles indicating a degree of oxidation may be a weight ratio of 99:1 to 33:67. The silicon particles may be SiOₓ particles, wherein the range of x in SiOₓ may be greater than 0 and less than 2. Here, the average particle size (D50) is measured by a particle size analyzer using laser diffraction and means the diameter of particles with a cumulative 50 volume % in the particle size distribution.

The Si-based negative electrode active material or Sn-based negative electrode active material may be used by mixing with a carbon-based negative electrode active material. When the Si-based negative electrode active material or Sn-based negative electrode active material and the carbon-based negative electrode active material are mixed and used, the mixing ratio may be a weight ratio of 1:99 to 90:10.

A content of the negative electrode active material in the negative electrode active material layer may be 95 wt % to 99 wt % based on a total weight of the negative electrode active material layer.

In an embodiment, the negative electrode active material layer further includes the binder and optionally may further include the conductive material. A content of the binder in the negative electrode active material layer may be 1 wt % to 5 wt % based on a total weight of the negative electrode active material layer. In addition, if a conductive material is further included, the negative electrode active material layer may include 90 wt % to 98 wt % of the negative electrode active material, 1 wt % to 5 wt % of the binder, and 1 wt % to 5 wt % of the conductive material.

The binder serves to well adhere the negative electrode active material particles to each other and also to adhere the negative electrode active material to the current collector. The binder may include a water-insoluble binder, a water-soluble binder, or a combination thereof.

The water-insoluble binder may include, for example, polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoro ethylene, polyvinylidene fluoride, polyethylene, polypropylene, polyamideimide, polyimide, or a combination thereof.

The water-soluble binder may include a rubber-based binder or a polymer resin binder. The rubber-based binder may be selected from a styrene-butadiene rubber, an acrylated styrene-butadiene rubber, an acrylonitrile-butadiene rubber, an acrylic rubber, a butyl rubber, a fluororubber, and a combination thereof. The polymer resin binder may be selected from polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, and a combination thereof.

When a water-soluble binder is used as the negative electrode layer binder, a thickener capable of imparting viscosity may be used together, and the thickener may include, for example, a cellulose-based compound. The cellulose-based compound may include carboxymethyl cellulose, hydroxypropylmethyl cellulose, methyl cellulose, an alkali metal salt thereof, or a combination thereof. The alkali metal may be Na, K, or Li. The amount of the thickener used may be 0.1 parts by weight to 3 parts by weight based on 100 parts by weight of the negative electrode active material.

The conductive material is used to provide conductivity to the electrode, and may include, for example, a carbon-based material such as natural graphite, artificial graphite, carbon black, acetylene black, ketjen black, a carbon fiber, and a carbon nanotube; a metal-based material in the form of metal powder or metal fibers, including copper, nickel, aluminum, and silver; a conductive polymer such as a polyphenylene derivative; or a mixture thereof.

The negative electrode current collector may include one selected from a copper foil, a nickel foil, a stainless steel foil, a titanium foil, a nickel foam, a copper foam, a polymer substrate coated with a conductive metal, and a combination thereof.

Another negative electrode layer for example the all-solid-state battery may be a precipitation-type negative electrode layer. The precipitation-type negative electrode layer refers to a negative electrode layer that does not include negative electrode active material when the battery is assembled, but in which lithium metal, etc. is precipitated when the battery is charged, and this acts as the negative electrode active material.

FIG. 4 is a schematic cross-sectional view of an all-solid-state battery including a precipitation-type negative electrode layer. Referring to FIG. 4, the precipitation-type negative electrode layer 400′ may include a current collector 401 and a negative electrode coating layer 405 on the current collector. An all-solid-state battery having such a precipitation-type negative electrode layer 400′ starts initial charging in the absence of a negative electrode active material, and when charging, high-density lithium metal, etc. is precipitated between the current collector 401 and the negative electrode coating layer 405 to form a lithium metal layer 404, which can serve as a negative electrode active material. Accordingly, in an all-solid-state battery that has been charged more than once, the precipitation-type negative electrode layer 400′ may include a current collector 401, a lithium metal layer 404 on the current collector, and a negative electrode coating layer 405 on the metal layer. The lithium metal layer 404 refers to a layer in which lithium metal, etc. is precipitated during a charging process of the battery, and can be referred to as a metal layer or negative electrode active material layer.

The negative electrode coating layer 405 is a metal, carbon material, or a combination thereof that acts as a catalyst.

The metal may include, for example, gold, platinum, palladium, silicon, silver, aluminum, bismuth, tin, zinc, or a combination thereof, and may be composed of one of these or various types of alloys. If the metal is present in particle form, an average particle diameter (D50) thereof may be less than or equal to about 4 μm, for example, 10 nm to 4 μm.

The carbon material may be, for example, crystalline carbon, amorphous carbon, or a combination thereof. The crystalline carbon may be for example natural graphite, artificial graphite, mesophase carbon microbeads, or a combination thereof. The amorphous carbon may be for example carbon black, activated carbon, acetylene black, denka black, ketjen black, or a combination thereof.

If the negative electrode coating layer 405 includes the metal and the carbon material, the metal and the carbon material may be, for example, mixed in a weight ratio of 1:10 to 2:1. Here, the precipitation of the lithium metal may be effectively promoted and improve characteristics of the all-solid-state battery. The negative electrode coating layer 405 may include, for example, a carbon material on which a catalyst metal is supported or a mixture of metal particles and carbon material particles.

The negative electrode coating layer 405 may include, for example the metal and amorphous carbon, and in this case, the deposition of lithium metal may be effectively promoted.

The negative electrode coating layer 405 may further include a binder, and the binder may be a conductive binder. Additionally, the negative electrode coating layer 405 may further include general additives such as a filler, a dispersant, an ion conductive agent, and the like.

A thickness of the negative electrode coating layer 405 may be for example 100 nm to 20 μm, 500 nm to 10 μm, or 1 μm to 5 μm.

The precipitation-type negative electrode layer 400′ may further include a thin film, for example, on the surface of the current collector, that is, between the current collector and the negative electrode catalyst layer. The thin film may include an element capable of forming an alloy with lithium. The element capable of forming an alloy with lithium may be, for example, gold, silver, zinc, tin, indium, silicon, aluminum, bismuth, and the like, which may be used alone or an alloy of more than one. The thin film may further planarize a precipitation shape of the lithium metal layer 404 and much improve characteristics of the all-solid-state battery. The thin film may be formed, for example in a vacuum deposition method, a sputtering method, a plating method, and the like. The thin film may have, for example, a thickness of 1 nm to 500 nm.

### Solid Electrolyte Layer

The solid electrolyte layer 300 may include a sulfide-based solid electrolyte, an oxide-based solid electrolyte, etc. The specific details of the sulfide-based solid electrolyte and the oxide-based solid electrolyte are as described above.

In one example, the solid electrolyte included in the positive electrode layer 200 and the solid electrolyte included in the solid electrolyte layer 300 may include the same compound or may include different compounds. For example, when both the positive electrode layer 200 and the solid electrolyte layer 300 include an argyrodite-type sulfide-based solid electrolyte, the overall performance of the all-solid-state rechargeable battery can be improved. In addition, as an example, when both the positive electrode layer 200 and the solid electrolyte layer 300 include the above-described coated solid electrolyte, the all-solid-state rechargeable battery can realize high capacity and high energy density while also realizing excellent initial efficiency and cycle-life characteristics.

Meanwhile, the average particle diameter (D50) of the solid electrolyte included in the positive electrode layer 200 may be smaller than the average particle diameter (D50) of the solid electrolyte included in the solid electrolyte layer 300. In this case, the energy density of the all-solid-state battery can be maximized while increasing the mobility of lithium ions to improve the overall performance. For example, the average particle diameter (D50) of the solid electrolyte included in the positive electrode layer 200 may be 0.1 μm to 1.0 μm, or 0.1 μm to 0.8 μm, and the average particle diameter (D50) of the solid electrolyte included in the solid electrolyte layer 300 may be 1.5 μm to 5.0 μm, or 2.0 μm to 4.0 μm, or 2.5 μm to 3.5 μm. When this particle size range is satisfied, the energy density of the all-solid-state rechargeable battery may be maximized while the transfer of lithium ions is facilitated, thereby suppressing resistance and improving the overall performance of the all-solid-state rechargeable battery. Here, the average particle diameter (D50) of the solid electrolyte can be measured using a particle size analyzer using laser diffraction. Alternatively, about 20 particles are randomly selected from a microscope image, such as a scanning electron microscope, and their particle sizes are measured to obtain a particle size distribution, and the D50 value is calculated therefrom.

The solid electrolyte layer may further include a binder in addition to the solid electrolyte. At this time, the binder may be a styrene butadiene rubber, polytetrafluoroethylene, polyvinylidene fluoride, polyethylene, acrylate polymers or a combination thereof, but is not limited thereto, and any binder used in the relevant technical field can be used. The acrylate-based polymer may be, for example, butyl acrylate, polyacrylate, polymethacrylate or a combination thereof.

The solid electrolyte layer may be formed by adding a solid electrolyte to a binder solution, coating the same on a base film, and drying. The solvent of the binder solution may be isobutyryl isobutyrate, xylene, toluene, benzene, hexane, or a combination thereof. Because the solid electrolyte layer formation process is widely known in the art, a detailed description will be omitted.

The thickness of the solid electrolyte layer may be, for example, 10 μm to 150 μm.

The solid electrolyte layer may further include an alkali metal salt, and/or an ionic liquid, and/or a conductive polymer.

For example, the alkali metal salt may be lithium salt. The content of lithium salt in the solid electrolyte layer may be greater than or equal to 1 M or for example 1 M to 4 M. In this case, the lithium salt can improve ionic conductivity by improving lithium ion mobility in the solid electrolyte layer.

The lithium salt may include, for example, LiSCN, LiN(CN)₂, Li(CF₃SO₂)₃C, LiC₄F₉SO₃, LiN(SO₂CF₂CF₃)₂, LiCl, LiF, LiBr, LiI, LiB(C₂O₄)₂, LiBF₄, LiBF₃(C₂F₅), lithium bis(oxalato)borate (LiBOB), lithium oxalyldifluoroborate (LIODFB), lithium difluoro(oxalato)borate (LiDFOB), lithium bis(trifluoro methanesulfonyl)imide (LiTFSI, LiN(SO₂CF₃)₂), lithium bis(fluorosulfonyl)imide (LiFSI, LiN(SO₂F)₂), LiCF₃SO₃, LiAsF₆, LiSbF₆, LiClO₄, or a mixture thereof.

In addition, the lithium salt may be an imide-based lithium salt, and for example, the imide-based lithium salt may include lithium bis(trifluoro methanesulfonyl)imide (LiTFSI, LiN(SO₂CF₃)₂), lithium bis(fluorosulfonyl)imide (LiFSI, LiN(SO₂F)₂). The lithium salt can maintain or improve ionic conductivity by maintaining appropriate chemical reactivity with ionic liquid.

The ionic liquid has a melting point below room temperature, so it is in a liquid state at room temperature and refers to a salt or room temperature molten salt composed of ions alone.

The ionic liquid may be a compound including a) at least one cation selected from ammonium-based, pyrrolidinium-based, pyridinium-based, pyrimidinium-based, imidazolium-based, piperidinium-based, pyrazolium-based, oxazolium-based, pyridazinium-based, phosphonium-based, sulfonium-based, or triazolium-based cation, and a mixture thereof, and b) at least one anion selected from BF₄—, PF₆—, AsF₆—, SbF₆—, AlCl₄—, HSO₄—, ClO₄—, CH₃SO₃—, CF₃CO₂—, Cl—, Br—, I—, BF₄—, SO₄—, CF₃SO₃—, (FSO₂)₂N—, (C₂F₅SO₂)₂N—, (C₂F₅SO₂)(CF₃SO₂)N—, and (CF₃SO₂)₂N—.

The ionic liquid may be, for example, one or more selected from N-methyl-N-propylpyrrolidinium bis(trifluoromethanesulfonyl)imide N-butyl-N-methylpyrrolidium bis(3-trifluoromethylsulfonyl)imide, 1-butyl-3-methylimidazolium bis(trifluoromethylsulfonyl)amide, and 1-ethyl-3-methylimidazolium bis(trifluoromethylsulfonyl)amide.

In the solid electrolyte layer, a weight ratio of the solid electrolyte and the ionic liquid in the solid electrolyte membrane may be 0.1:99.9 to 90:10, for example 10:90 to 90:10, 20:80 to 90:10, 30:70 to 90:10, 40:60 to 90:10, or 50:50 to 90:10. The solid electrolyte layer satisfying the above ranges may maintain or improve ionic conductivity by improving the electrochemical contact area with the electrode. Accordingly, the energy density, discharge capacity, rate capability, etc. of the all-solid-state battery may be improved.

The all-solid-state battery may be a unit cell with a structure of positive electrode layer/solid electrolyte layer/negative electrode layer, a bicell with a structure of positive electrode layer/solid electrolyte layer/negative electrode layer/solid electrolyte layer/positive electrode layer, or a stacked battery in which the structure of the unit cell is repeated.

The shape of the all-solid-state battery is not particularly limited, and may be, for example, coin-shaped, button-shaped, sheet-shaped, stacked-shaped, cylindrical, flat, etc. In addition, the all-solid-state battery may be applied to a large-sized battery used in an electric vehicle or the like. For example, the all-solid-state battery may also be used in hybrid vehicles such as plug-in hybrid electric vehicles (PHEV). In addition, it may be used in a field requiring a large amount of power storage, and may be used, for example, in an electric bicycle or a power tool.

### MODE FOR INVENTION

Hereinafter, examples and comparative examples of the present invention will be described. The following examples are only examples of the present invention and the present invention is not limited to the following examples.

### Example 1

### (1) Preparation of Solid Electrolyte Composite

As diamagnetic particles, needle-shaped artificial graphite with an aspect ratio of 4.2, a minor axis length of 1.2 μm, and a major axis length of 5 μm was prepared. In addition, as a raw material for manufacturing Li₆PS₅Cl, a type of argyrodite-type sulfide-based solid electrolyte, Li₂S, P₂S₅, and LiCl were prepared in a molar ratio of 5:1:2.

In the presence of acetonitrile, the first solvent, the solid electrolyte raw material and the diamagnetic particles were mixed at a weight ratio of 30:1, magnetically stirred for 2 hours, dried at 120° C., and then heat-treated at 550° C.

Accordingly, a solid electrolyte composite including a core including plate-shaped artificial graphite; and a shell surrounding the core and including Li₆PS₅Cl was obtained.

### (2) Preparation of Positive Electrode Slurry

In octyl acetate, a second solvent, 3.44 parts by weight of the solid electrolyte composite, 10 parts by weight of an amorphous solid electrolyte (Li₆PS₅Cl), 0.85 parts by weight of a positive electrode active material (LiNi_{0.8}Co_{0.1}Al_{0.1}O₂), 1 part by weight of a binder (PVdF), 0.4 parts by weight of a conductive material (CNT), and 0.16 parts by weight of a dispersant (H-NBR) were mixed to prepare a positive electrode slurry.

### (3) Manufacturing of Positive Electrode Layer

Aluminum foil having a thickness of 12 μm was used as a positive electrode current collector, and 22 mg/cm² of the positive electrode slurry was coated onto one surface of the positive electrode current collector.

A magnetic field was applied to the positive electrode slurry coated on one surface of the positive electrode current collector at 25° C. with a strength of 0.5 to 2 T for 0.1 second to 10 minutes.

After the magnetic field was applied, the positive electrode slurry was dried to remove the solvent, and the positive electrode active material formed thereby and the positive electrode active material were collectively compressed.

Accordingly, a positive electrode layer was obtained.

### (4) Manufacturing of Negative Electrode Layer

A nickel foil with a thickness of 10 μm was prepared as a negative electrode current collector. Additionally, carbon black (CB) particles having a D50 particle size of about 30 nm and silver (Ag) particles having a D50 particle size of about 60 nm were prepared as materials to form a negative electrode coating layer.

A mixed powder of 0.25 g of carbon black (CB) and silver (Ag) particles in a weight ratio of 3:1 was placed in a container, and 2 g of an NMP solution including 7 wt % of PVDF binder (#9300 from Kureha) was added to prepare a mixed solution. Next, NMP was added little by little to the mixed solution and the mixed solution was stirred to prepare a slurry. The prepared slurry was coated on a Ni foil using a bar coater and dried in a convection oven at 80° C. for 10 minutes to obtain a stack. The obtained stack was vacuum dried at 100° C. for more than 8 hours, i.e., 10 hours. Through the above process, a negative electrode layer was manufactured in which a negative electrode coating layer was formed on a negative electrode current collector.

### (5) Manufacturing of Solid Electrolyte Layer

A 4 wt % binder solution was prepared by adding an acrylic binder (SX-A334, Zeon Co., Ltd.) to octyl acetate. An acrylic binder solution was prepared by adding it to a Li₆PS₅Cl solid electrolyte (D50=3 um, crystalline) of argyrodite-type crystals and mixing it with a Thinky mixer to prepare a slurry. The slurry included 1.5 parts by weight of acrylic binder based on 98.5 parts by weight of solid electrolyte. The prepared slurry was coated onto a nonwoven fabric using a bar coater and dried in a convection oven at 50° C. for 5 minutes to obtain a stack. The obtained stack was dried in a vacuum oven at 40° C. for 10 hours or more. A solid electrolyte layer was manufactured by the above processes.

(6) Manufacturing of all-Solid-State Rechargeable Battery Cell

A stack was prepared by placing the solid electrolyte layer between the positive electrode layer and the negative electrode layer. The prepared stack was subjected to hot-plate press at 80° C. and 500 MPa of pressure for 30 min to manufacture an all-solid-state rechargeable battery cell. By this pressing process, the solid electrolyte layer was sintered, thereby improving the battery characteristics. The thickness of the pressed positive electrode active material layer was about 100 μm, the thickness of the pressed negative electrode coating layer was 7 μm, and the thickness of the pressed solid electrolyte layer is 60 μm.

### Example 2

In the preparation of the solid electrolyte composite, the needle-shaped artificial graphite having an aspect ratio of 4.2, a minor axis length of 1.2 μm, and a major axis length of 5 μm was replaced with needle-shaped artificial graphite having an aspect ratio of 1.7, a minor axis length of 3.5 μm, and a major axis length of 6 μm. Other than these, the positive electrode layer and all-solid-state rechargeable battery cell of Comparative Example 1 were manufactured in the same manner as in Example 1.

### Comparative Example 1

In the preparation of the positive electrode slurry, 3.44 parts by weight of the above solid electrolyte composite and 10 parts by weight of the amorphous solid electrolyte (Li₆PS₅Cl) were replaced with 13.44 parts by weight of the amorphous solid electrolyte (Li₆PS₅Cl) alone. Other than these, the positive electrode layer and all-solid-state rechargeable battery cell of Comparative Example 1 were manufactured in the same manner as in Example 1.

### Comparative Example 2

In the preparation of the positive electrode slurry, 3.44 parts by weight of the above solid electrolyte composite was replaced with 3.44 parts by weight of needle-shaped artificial graphite having an aspect ratio of 1.7, a minor axis length of 3.5 μm, and a major axis length of 6 μm.

Other than these, the positive electrode layer and all-solid-state rechargeable battery cell of Comparative Example 2 were manufactured in the same manner as in Example 1.

### Comparative Example 3

In the preparation of the solid electrolyte composite, the needle-shaped artificial graphite having an aspect ratio of 4.2, a minor axis length of 1.2 μm, and a major axis length of 5 μm was replaced with needle-shaped artificial graphite having an aspect ratio of 1.0, a minor axis length of 7 μm, and a major axis length of 7 μm. Other than these, the positive electrode layer and all-solid-state rechargeable battery cell of Comparative Example 1 were manufactured in the same manner as in Example 1.

For reference, the structures of the solid electrolyte composites formed by Examples 1 and 2 and Comparative Examples 1 to 3; the shape, aspect ratio, minor axis length and minor axis length of the core; and the weight ratio of the core and shell are shown in Table 1.

TABLE 1

| | Solid electrolyte | Core | | | | | |
|---|---|---|---|---|---|---|---|
| | composite | | Aspect | Minor axis | | Major axis | Core:shell |
| | structure | Shape | ratio | length | | length | weight ratio |
| Example 1 | diamagnetic | needle- | 4.2 | 1.2 | μm | 5 μm | 1:30 |
| | particles core- | shaped | | | | | |
| Example 2 | solid electrolyte | needle- | 1.7 | 3.5 | μm | 6 μm | 1:30 |
| | shell | shaped | | | | | |
| Comparative | solid electrolyte | irregular | — | — | | — | — |
| Example 1 | alone | shaped | | | | | |
| Comparative | diamagnetic | needle- | 1.7 | 3.5 | μm | 6 μm | — |
| Example 2 | particles alone | shaped | | | | | |
| Comparative | diamagnetic | spherical | 1.0 | 7 | μm | 7 μm | 1:30 |
| Example 3 | particles core- | shape | | | | | |
| | solid electrolyte | | | | | | |
| | shell | | | | | | |

### Evaluation Example 1: Ionic Conductivity of Positive Electrode Layer

For each positive electrode layer of Examples and Comparative Examples, ionic conductivity was evaluated.

Specifically, the positive electrode layer was placed in a mold with a diameter of 10 mm and pressed at a pressure of 350 mPa to form a pellet. Samples for measuring ionic conductivity were prepared by coating an indium (In) thin film on both surfaces of the pellet. For the prepared samples, impedance was measured using an AUTOLAB PGSTAT30 (Metrohm Autolab Co. Ltd.) potentiostat, and a Nyquist plot was plotted, from which the ionic conductivity was measured at 45° C. The results are shown in Table 2.

TABLE 2

| | Ionic conductivity |
|---|---|
| | (mS/cm) (@ 45° C.) |
| Example 1 | 0.28 |
| Example 2 | 0.22 |
| Comparative Example 1 | 0.19 |
| Comparative Example 2 | 0.08 |
| Comparative Example 3 | 0.17 |

According to Table 2, the positive electrode layers of Examples 1 and 2 have higher ionic conductivity than the positive electrode layers of Comparative Examples 1 to 3. The positive electrode layers of Examples 1 and 2 used a core-shell structured solid electrolyte composite including a core including diamagnetic particles having an aspect ratio of greater than 1; and a solid electrolyte surrounding the core. Accordingly, as a magnetic field was applied during the manufacturing processes of Examples 1 and 2, the solid electrolyte composite could be oriented in a direction perpendicular or nearly perpendicular (e.g., 50° to 130°) in the positive electrode active material layer. According to this orientation, the lithium ion movement path within the positive electrode layer (particularly, the positive electrode active material layer) of Examples 1 and 2 is shortened, and high ionic conductivity is achieved.

However, the positive electrode layer of Comparative Example 1 used an amorphous solid electrolyte itself instead of the solid electrolyte composite of Examples 1 and 2. Accordingly, even if a magnetic field was applied during the process of manufacturing the positive electrode layer of Comparative Example 1, the amorphous solid electrolyte itself could not help but be randomly oriented in the positive electrode active material layer.

The positive electrode layer of Comparative Example 3 used a composite in which a solid electrolyte shell was formed on a spherical diamagnetic particle core instead of the solid electrolyte composites of Examples 1 and 2. Accordingly, even if a magnetic field was applied during the process of manufacturing the positive electrode layer of Comparative Example 3, the complex in which the solid electrolyte shell is formed on the spherical diamagnetic particle core could not help but be oriented in the positive electrode active material layer.

Meanwhile, the positive electrode layer of Comparative Example 2 used needle-shaped artificial graphite without a solid electrolyte shell formed instead of the solid electrolyte composite. Accordingly, during the process of manufacturing the positive electrode layer of Comparative Example 2, the orientation of the needle-shaped artificial graphite in which the solid electrolyte shell was not formed may be close to perpendicular in the positive electrode active material layer due to the applied magnetic field. However, because the solid electrolyte shell is not formed, the ionic conductivity of the positive electrode layer of Comparative Example 2 could not but be lower than those of Examples 1 and 2.

### Evaluation Example 2: High-Rate Capability of all-Solid-State Rechargeable Battery Cell

For each all-solid-state rechargeable battery cells of Examples and Comparative Examples, high-rate capability was evaluated.

Specifically, the battery cells were charged at a constant current of 0.1 C until the battery voltage became 4.25 V in a constant temperature bath at 45° C., and discharged at a constant current of 0.1 C until the battery voltage became 2.5 V (first cycle); the battery cells were charged at a constant current of 0.1 C until the battery voltage became 4.25 V, and discharged at a constant current of 0.33 C until the battery voltage became 2.5 V (second cycle); and the battery cells were charged at a constant current of 0.1 C until the battery voltage became 4.25 V, and discharged at a constant current of 1.0 C until the battery voltage became 2.5 V (third cycle).

The discharge capacity and high-rate capability in each cycle are shown in Table 2. Here, the high-rate capability is defined by Equation 4.

$$[ Equation 4 ]$$

$$High - rate capability [ \% ] = [ Discharge capacity in the 3 rd cycle ( 1 C rate ) / Discharge capacity in the 1 st cycle ( 0.1 C rate ) ] \times 100 [ \% ]$$

TABLE 3

| | 0.1 C | 0.33 C | 1 C | |
|---|---|---|---|---|
| | discharge | discharge | discharge | High-rate |
| | capacity | capacity | capacity | capability |
| | (mAh/g) | (mAh/g) | (mAh/g) | (%) |
| Example 1 | 191 | 188 | 172 | 90.1 |
| Example 2 | 189 | 185 | 169 | 89.4 |
| Comparative Example 1 | 189 | 182 | 166 | 87.8 |
| Comparative Example 2 | 154 | 107 | 75 | 48.7 |
| Comparative Example 3 | 187 | 181 | 164 | 87.7 |

According to Table 3, the all-solid-state rechargeable battery cells of Examples 1 and 2 exhibited superior high-rate capability as well as discharge capacity in each cycle compared to the all-solid-state rechargeable battery cells of Comparative Examples 1 to 3. Through this, it was found that the high-rate capability of the all-solid-state rechargeable battery cells were improved by manufacturing a solid electrolyte composite in the form of a core including non-spherical diamagnetic particles; a shell including a solid electrolyte thereon; and orienting the solid electrolyte composite in a direction close to perpendicular to the positive electrode current collector. While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

<Description of symbols>

| | |
|---|---|
| 1: solid electrolyte composite | 1a: core |
| 1b: shell | 100: all-solid-state rechargeable battery |
| 200: positive electrode layer | 201: positive electrode current collector |
| 203: positive electrode active | 300: solid electrolyte layer |
| material layer | |
| 400: negative electrode layer | 400′: precipitation-type negative |
| | electrode layer |
| 401: positive electrode current | 403: negative electrode active material |
| collector | layer |
| 404: lithium metal layer | 405: negative electrode coating layer |
| 500: elastic layer | |

1. A positive electrode layer for an all-solid-state rechargeable battery, comprising
a positive electrode current collector; and a positive electrode active material layer located on the positive electrode current collector and including a solid electrolyte composite and a positive electrode active material;
wherein the solid electrolyte composite includes a core including diamagnetic particles having an aspect ratio represented by Equation 1 of greater than 1; and a shell surrounding the core and including a solid electrolyte:
Aspect ratio=length of major axis/length of minor axis. [Equation 1]

2. The positive electrode layer for the all-solid-state rechargeable battery as claimed in claim 1, wherein
the major axis of the solid electrolyte composite in the positive electrode active material layer is oriented in a direction of 50° to 130° with respect to the positive electrode current collector.

3. The positive electrode layer for the all-solid-state rechargeable battery as claimed in claim 1, wherein
the solid electrolyte composite comprises the core and the shell in a weight ratio of 1:1 to 1:500.

4. The positive electrode layer for the all-solid-state rechargeable battery as claimed in claim 1, wherein
the core has a needle-shape, plate-shape, or oval shape.

5. The positive electrode layer for the all-solid-state rechargeable battery as claimed in claim 1, wherein
the core comprises a carbon-based material selected from artificial graphite, natural graphite, graphene, a carbon nanotube (CNT), an L-carbon nanotube (long length CNT), a carbon fiber, carbon black, or a combination thereof as diamagnetic particles.

6. The positive electrode layer for the all-solid-state rechargeable battery as claimed in claim 1, wherein
the shell comprises a sulfide-based solid electrolyte, an oxide-based solid electrolyte, a polymer-based solid electrolyte, or a solid electrolyte selected from these.

7. The positive electrode layer for the all-solid-state rechargeable battery as claimed in claim 1, wherein
the positive electrode active material comprises a composite oxide of lithium and nickel, manganese, cobalt, or a combination thereof.

8. The positive electrode layer for the all-solid-state rechargeable battery as claimed in claim 1, wherein
the positive electrode active material layer further comprises an amorphous sulfide-based solid electrolyte, a conductive material, a binder, or a combination thereof.

9. The positive electrode layer for the all-solid-state rechargeable battery as claimed in claim 8, wherein
the conductive material is at least one selected from graphite, carbon black, acetylene black, a carbon nanofiber, and a carbon nanotube.

10. The positive electrode layer for the all-solid-state rechargeable battery as claimed in claim 9, wherein
the binder is at least one selected from polyvinylidene fluoride, a styrene butadiene rubber, polytetrafluoroethylene, polyvinylidene fluoride, a vinylidene fluoride/hexafluoropropylene copolymer, polyacrylonitrile, and polymethyl methacrylate.

11. A method for manufacturing a positive electrode layer for an all-solid-state rechargeable battery, comprising
preparing a solid electrolyte composite including a core including diamagnetic particles having an aspect ratio represented by Equation 1 of greater than 1; and a shell surrounding the core and including a solid electrolyte;
preparing a positive electrode slurry including the solid electrolyte composite and a positive electrode active material;
coating the positive electrode slurry onto a positive electrode current collector; and
applying a magnetic field to the positive electrode slurry coated onto the positive electrode current collector:
Aspect ratio=length of major axis/length of minor axis [Equation 1]

12. The method for manufacturing the positive electrode layer for the all-solid-state rechargeable battery as claimed in claim 11, wherein
the preparing of the solid electrolyte composite comprises
preparing a mixed solution by mixing a first solvent, diamagnetic particles having an aspect ratio represented by Equation 1 of greater than 1;
drying the mixed solution; and
heat-treating the dried material.

13. The method for manufacturing the positive electrode layer for the all-solid-state rechargeable battery as claimed in claim 11, wherein
the preparing of the positive electrode slurry comprises
preparing a mixed slurry including a second solvent, the solid electrolyte composite, and a positive electrode active material.

14. The method for manufacturing the positive electrode layer for the all-solid-state rechargeable battery as claimed in claim 11, wherein
a strength of the magnetic field is 0.1 to 3 T.

15. The method for manufacturing the positive electrode layer for the all-solid-state rechargeable battery as claimed in claim 11, wherein
an application time is 0.1 second to 10 minutes.

16. The method for manufacturing the positive electrode layer for the all-solid-state rechargeable battery as claimed in claim 11, wherein
after applying a magnetic field to the positive electrode slurry coated onto the positive electrode current collector;
the method further comprises drying the positive electrode slurry to which the magnetic field has been applied, thereby forming a positive electrode active material layer on the positive electrode current collector; and
compressing the positive electrode current collector and the positive electrode active material layer formed on the positive electrode current collector.

17. An all-solid-state rechargeable battery, comprising
the positive electrode layer as claimed claim 1;
a negative electrode layer; and
a solid electrolyte layer between the positive electrode layer and the negative electrode layer.
